(19) United States
(12) Patent Application Publication
(10) Pub. No.: US 2006/0222280 A1
(43) Pub. Date: Oct. 5, 2006

(54) Shaft assembly

(76) Inventors: Hirotake Harada, Farmington Hills, MI (US); David Thomas Zdeb, Ypsilanti, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/094,890

(22) Filed: Mar. 31, 2005

(51) Int. Cl. F16C 43/04

(52) U.S. Cl. 384/561

(57) ABSTRACT

A shaft assembly is provided that has a shaft having a groove disposed in an outer surface of the shaft, a bearing disposed about a portion of the shaft, and a spacer. The spacer has at least a first side and a second side and is positioned at least partially in the groove. The first side and the second side are angled with respect to each other, such that a radially inward portion of the spacer has a narrower width than a radially outward portion of the spacer. At least a portion of the first side of the spacer engages a portion of the groove and at least a portion of the second side of the spacer exerts a longitudinal force towards the bearing.

### BACKGROUND

Shafts are used in a number of different applications, for example, for rotatably supporting wheels or other rotational components in a rear axle configuration for a vehicle. Typical shaft assemblies may include bearings to assist the rotation of the shaft.

Some prior art shaft assemblies involved the measuring of a gap associated with a shaft assembly, the selection of a shim having a correct thickness, and the installation of the specifically-sized and selected shim into the assembly.

Among other things, the present invention eliminates the need for providing multiple shims of various thicknesses (to properly match gaps of varying dimensions) and provides an assembly in which a novel spacer and configuration can instead be employed.

### BRIEF DESCRIPTION OF THE DRAWINGS

The invention will now be described, by way of example, with reference to the accompanying drawings, in which:

FIG. 1 is a schematic view of a shaft assembly according to an embodiment of the invention;

FIG. 2 is a schematic view of a shaft assembly according to an embodiment of the invention;

FIG. 3 is a cross-sectional view according to III-III in FIG. 2 of a shaft assembly according to an embodiment of the invention;

FIG. 4 is a cross-sectional view of a shaft assembly according to an embodiment of the invention;

FIG. 5 is a cross-sectional view of a shaft assembly according to an embodiment of the invention;

FIG. 6 is a schematic perspective view of a vehicle employing a shaft assembly according to an embodiment of the invention;

FIG. 7 is a cross-sectional view of a shaft assembly according to an embodiment of the invention;

FIG. 8 is a cross-sectional view of a shaft assembly according to an embodiment of the invention; and

FIG. 9 is a cross-sectional view of a shaft assembly according to an embodiment of the invention.

### DETAILED DESCRIPTION

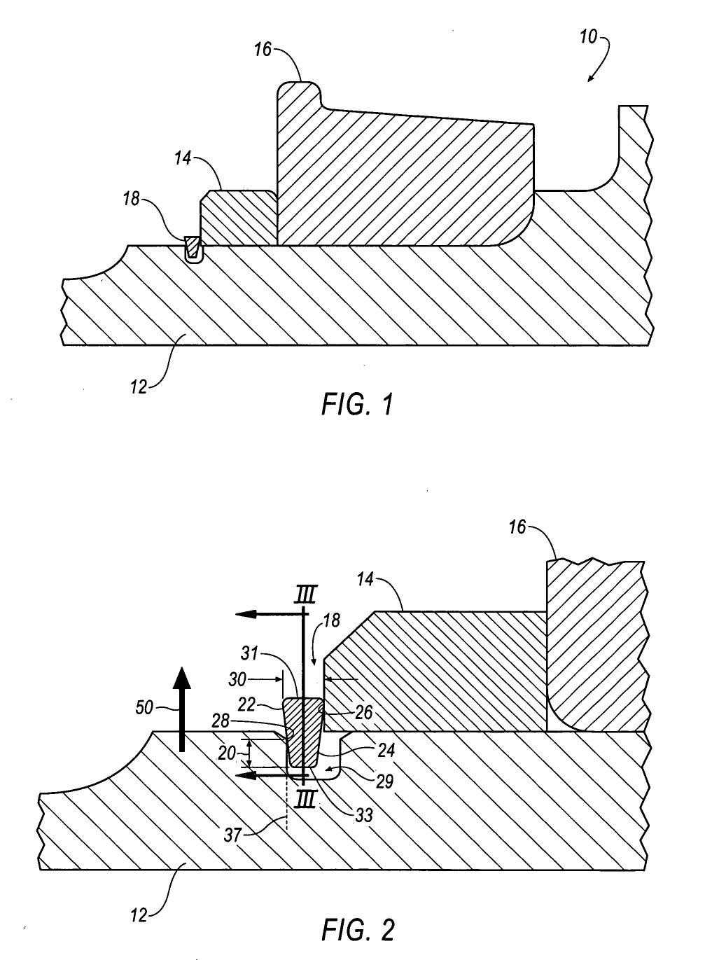

Referring to FIG. 1, an embodiment of a shaft assembly is shown and described. The illustrated assembly 10 is shown comprising a shaft 12, collar 14, bearing 16, and spacer 18. Shaft 12 can be any type of rotating shaft, such as a vehicle axle shaft, output shaft or other shaft, as will be readily understood by persons skilled in the art. One skilled in the art will readily recognize that the invention is not limited to the illustrated shaft and other shafts may be used in connection with the invention.

Collar 14 is positioned radially about shaft 12. Among other things, collar 14 may can be used to separate bearing 16 and spacer 18. Bearing 16 is generally positioned about the shaft 12 and, as will be readily understood by persons skilled in the art, may also provide rotational support for shaft 12.

As shown in the illustrated embodiment, spacer 18 may include a portion that is positioned in or extends at least partially into a recess, receiving portion, or groove, hereinafter referred to simply as a “groove.” In the embodiment illustrated in FIG. 2, an associated groove 29 is shown with respect to a portion of shaft 12. The spacer 18 can serve to minimize the space between the collar 14, and bearing 16, for instance, as further discussed below. However, with some embodiments of the invention, the assembly 10 may not include a collar 14. Instead, for example, bearing 16 may be positioned against spacer 18. Persons skilled in the art will recognize that many other configurations and variations of a shaft, collar, bearing and/or spacer may be employed in connection with the invention.

Referring again to FIG. 2, an embodiment of spacer 18 is described in greater detail. The spacer 18 may be a snap ring, washer, or other suitable component or combination of components. Among other things, such a spacer can reduce or minimize a gap between the bearing 16 and an adjacent component (such as a collar), to reduce or minimize the amount of axial movement of an associated bearing 16.

As illustrated in the embodiment shown in FIG. 2, spacer 18 may include a radially inward portion 33, a radially outward portion 31, and sidewalls 22 and 24. Further, if desired, one or both of the sidewalls 22,24 may include a tapered segment or portion (with respect to a radially normal direction, such as line 37) relative to the shaft 12. In the illustrated embodiment, sidewalls 22 and 24 are angled such that spacer 18 transitions from a wider portion (e.g., at or about radially outward portion 31) to a more narrow portion (e.g., at or about radially inward portion 33). Of course, persons skilled in the art will readily recognize that such a taper or contour need not be linear, but instead may be in the form of many other configurations, such as concave, convex, curved, or other suitable geometric configurations that permit spacer 18 to transition from a wider portion to a narrower portion and/or provide a desired “wedge effect.” Again, it should be understood that both illustrated sidewalls 22 and 24 are not required to include a tapered portion or segment, and instead, if desired, only one of sidewalls 22 and 24 may include a tapered portion.

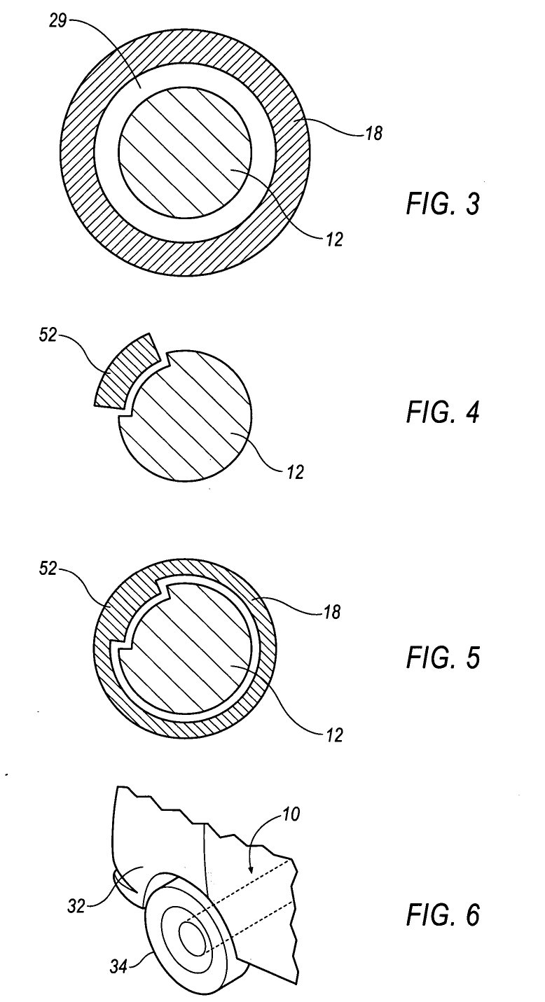

As shown in the embodiments depicted in FIGS. 2 and 3, spacer 18 may take the form of a ring that is positioned around associated shaft 12. A portion of spacer 18 may reside within groove 29 and may extend radially inward to a given depth (such as illustrated in FIG. 2 by the designation 20). A sufficient depth is typically desirable to prevent spacer 18 from slipping over shaft 12 in response to forces (e.g., longitudinally-directed forces) that may be generated by or relative to the components of the assembly 10. One skilled in the art will really recognize that the associated depth 20 may be configured or adjusted, as desired, to better retain a functionally desired or necessary portion of spacer 18 within the groove 29.

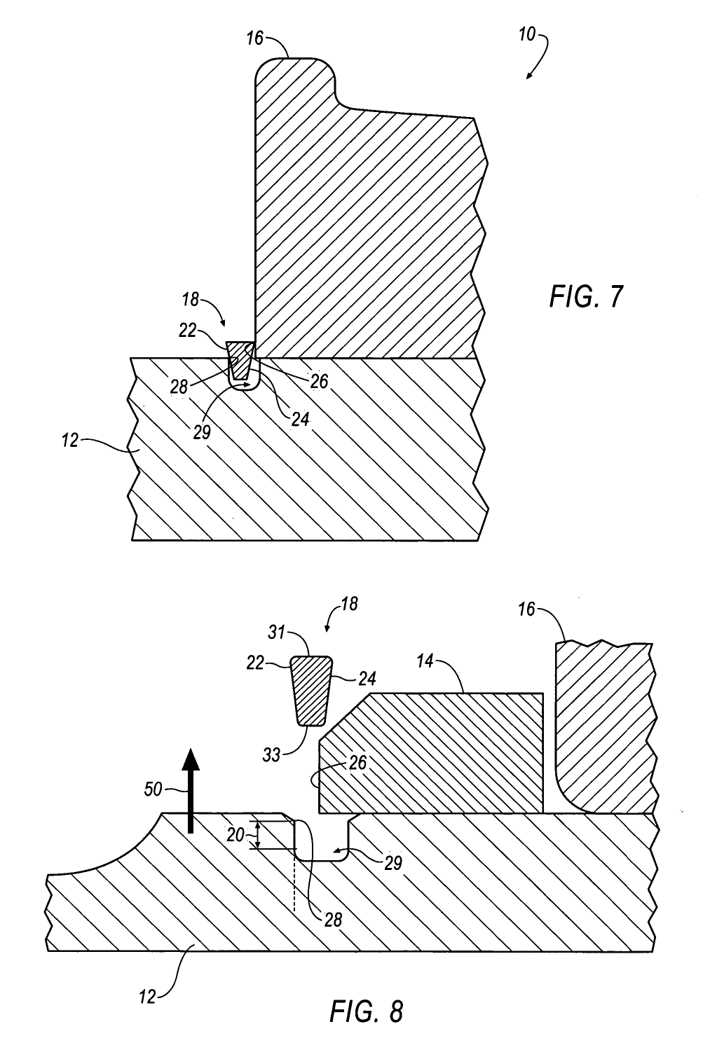

In the embodiment shown in FIG. 2, sidewall 22 of spacer 18 abuts at least a portion of a wall of groove 29 (for e.g., at or about an area generally designated 28). Likewise, sidewall 24 abuts collar 14 (e.g., at or about an area generally designated 26). In the illustrated embodiment, groove 29 and spacer 18 are substantially circular and surround a portion of shaft 12. However, although FIG. 3 illustrates spacer 18 with a substantially circular configuration, one skilled in the art will recognize that other embodiments of a spacer, such as portion 52 shown in FIG. 4, may be employed in connection with other embodiments. For example, without limitation, FIG. 5 illustrates an embodiment wherein a portion 52 (that interconnects with a periphery of shaft 12) may be supported by a remainder of the spacer 18. For such an embodiment, if desired, only portion 52 may have tapered sidewalls such as sidewalls 22 and 24. One skilled in the art will really recognize that a number of additional geometric configurations may be used in connection with embodiments of the present invention. FIG. 6 illustrates an embodiment of a shaft assembly in which the assembly 10 is used in connection with a vehicle 32 and wheel 34.

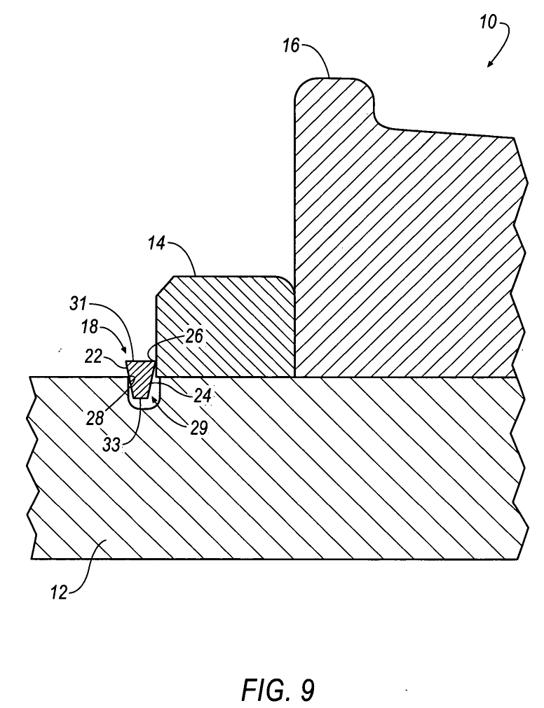

Additionally, as illustrated in the embodiment of an assembly 10 shown in FIG. 7, if desired, a portion of sidewall 24 of spacer 18 may directly abut a portion of bearing 16 and a collar (for example as illustrated in some previous embodiments) may be omitted.

Referring to FIGS. 8 and 9, an embodiment of a method for assembling the spacer 18 is shown and is hereinafter described. In FIG. 8, bearing 16 and collar 14 are positioned about shaft 12. Spacer 18 is shown generally positioned for insertion into groove 29. In FIG. 9, a portion of spacer 18 is shown inserted into groove 29 such that tapered sidewalls 22 and 24 engage portions of regions 28 and 26, respectively. The forces associated with the action and positioning of the spacer 18 serve to, among other things, force a portion of collar 14 against a portion of bearing 16 and serve to tighten the engagement or connection (i.e., to reduce or eliminate a gap) between the associated collar 14 and the bearing 16. Such a configuration can, among other things, serve to reduce the amount of slop or play in the assembly, including that associated with bearing 16.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A shaft assembly comprising:
a shaft having a groove disposed in an outer surface of the shaft;
a bearing disposed about a portion of the shaft; and
a spacer having at least a first side and a second side, the spacer positioned at least partially within the groove,
wherein the first side and the second side are angled with respect to each other, such that a radially inward portion of the spacer has a narrower width than a radially outward portion of the spacer, and
wherein at least a portion of the first side of the spacer engages at least a portion of the groove, and at least a portion of the second side of the spacer exerts a longitudinal force towards the bearing.

2. The shaft assembly according to claim 1, wherein the groove is disposed about a circumference of the shaft.

3. The shaft assembly according to claim 2, wherein the spacer is disposed about a circumference of the shaft.

4. The shaft assembly according to claim 1, including a collar positioned between the spacer and the bearing.

5. The shaft assembly according to claim 4, wherein at least a portion of the second side of the spacer engages the collar.

6. The shaft assembly according to claim 5, wherein the spacer exerts a longitudinal force on the collar and the bearing.

7. The shaft assembly according to claim 6, wherein at least a portion of the collar engages at least a portion of the bearing such that substantially no gap exists between the engaged portions of the collar and the bearing.

8. The shaft assembly according to claim 1, wherein the first side of the spacer includes a tapered segment, the second side of the spacer includes a tapered segment, or both the first and second sides of the spacer include tapered segments.

9. The shaft assembly according to claim 1, wherein the spacer is inserted into the groove to a depth.

10. The shaft assembly according to claim 9, wherein when the spacer is inserted into the groove to the depth and the spacer is configured to provide the longitudinal force that is directed toward the bearing.

11. The shaft assembly according to claim 1, wherein less than one-half of the spacer is inserted into the groove.

12. The shaft assembly according to claim 1, wherein the spacer comprises a snap ring or washer.

13. A method for positioning a bearing on a shaft, comprising:
providing a bearing, a shaft, and a spacer having at least a first side and a second side;
disposing the bearing about the shaft, the shaft including a groove disposed in the outer surface of the shaft; and
inserting at least a portion of the spacer at least partially into the groove such that at least a portion of the first side of the spacer engages at least a portion of the groove and at least a portion of the second side of the spacer exerts a longitudinal force towards the bearing.

14. The method according to claim 13, including disposing a collar about the shaft and adjacent the bearing.

15. The method according to claim 14, wherein a portion of the spacer engages and exerts the longitudinal force on at least a portion of the collar.

16. The method according to claim 15, wherein at least a portion of the collar engages at least a portion of the bearing such that substantially no gap exists between the engaged portions of the collar and the bearing.

17. The method according to claim 13, wherein the first and second sides are angled with respect to each other, such that a radially inward portion of the spacer has a narrower width than a radially outward portion of the spacer.

18. The method according to claim 13, wherein less than one-half of the spacer is inserted into the groove.

19. A vehicle comprising
a shaft assembly including:
a shaft having a groove disposed in the outer surface of the shaft;
a bearing disposed about a portion of the shaft; and
a spacer having at least a first side and a second side, the spacer being positioned at least partially within the groove,
wherein the first side and the second side of the spacer are angled with respect to each other, such that a radially inward portion of the spacer has a narrower width than a radially outward portion of the spacer, and
wherein a portion of the first side of the spacer engages a portion of the groove, and at least a portion of the second side of the spacer exerts a longitudinally force towards the bearing.

20. The vehicle according to claim 19, including a collar positioned between the spacer and the bearing.
